(19) United States
(12) Patent Application Publication
(10) Pub. No.: US 2018/0357671 A1
(43) Pub. Date: Dec. 13, 2018

(54) MARK TRIGGERED CONTENT RECOMMENDATIONS

(71) Applicant: Hewlett-Packard Development Company, L.P., Houston, TX (US)

(72) Inventors: Renato Oliveria, Porto Alegre (BR); Lucio Cossio, Porto Alegre (BR); Fernanda Gallina, Porto Alegre (BR); Daniele pINHEIRO, Porto Alegre (BR); Julia Freitas, Porto Alegre (BR); Rafael Bessega, Porto Alegre (BR); Sidney Reis, Porto Alegre (BR)

(21) Appl. No.: 15/579,857

(22) PCT Filed: Aug. 20, 2015
(86) PCT No.: PCT/US2015/046106

§ 371 Date: Dec. 5, 2017

(51) Int. Cl. G06Q 30/02; G06K 7/14; G06K 19/06; G06F 17/30

(52) U.S. Cl. CPC G06Q 30/0261; G06K 7/1417; G06F 17/30241; G06F 17/30879; G06K 19/06037

(57) ABSTRACT

In one implementation, a system for providing mark triggered content recommendations include a data engine to receive a scanned image ID of a first mark with a corresponding location of the first mark, a location engine to determine a location of a second mark within a radius of the corresponding location of the first mark, and a content engine to provide content associated with the first mark and a recommendation of content associated with the second mark.

### BACKGROUND

Marks can be associated with content so that when the mark is scanned the content associated with the mark can be provided. A user can utilize a scanning device to scan a particular mark to gain access to the content associated with the mark. The marks can be positioned at a number of physical locations. In some cases, it can be difficult for a user to locate the mark at a particular physical location or may not be aware that a particular mark is located at the physical location. In some cases, a user may not have a scanning functionality and is unable to scan the mark.

### BRIEF DESCRIPTION OF THE DRAWINGS

FIG. 1 illustrates a diagram of an example of a system for providing mark triggered content recommendations consistent with the present disclosure.

FIG. 2 illustrates a diagram of an example computing device for providing mark triggered content recommendations consistent with the present disclosure.

FIG. 3 illustrates an example system for providing mark triggered content recommendations consistent with the present disclosure.

FIG. 4 illustrates an example system for providing mark triggered content recommendations consistent with the present disclosure.

FIG. 5 illustrates an example method for providing mark triggered content recommendations consistent with the present disclosure.

### DETAILED DESCRIPTION

A number of methods, systems, and computer readable medium for providing mark triggered content recommendations are described herein. Mark triggered content recommendations can include providing recommendations of content to devices when the devices are within an area of a mark associated with the content. That is, a device can receive a number of recommendations of content associated with marks within a radius of a location of the device. As used herein, content associated with a mark includes content that can be accessed when the mark is scanned by a device. The recommendations can include a link to the content associated with the mark. The link can be a hyperlink or other type of link that can be utilized to provide the content associated with the mark even without scanning the mark with the device. In some examples, the mark can be a visual mark displayed at a corresponding location.

In previous examples, the device may be required to scan the mark to access the content associated with the mark. In the present disclosure, the content of the mark can be provided to the device without access to the mark and/or without scanning the mark. Thus, the recommendation can provide scanless access to the content associated with the mark. In some examples, the location (e.g., physical location) of the mark can be determined, mapped, and/or stored in a database based on a determined location of a device that has scanned the mark. For example, a device can scan the mark to be provided with content associated with the mark. In this example, the mark, location data of the device scanning the mark, a user ID associated with the device, and/or other data of the event (e.g., timestamp, etc.) can be sent to a service and utilized to map the mark and corresponding content. Furthermore, in this example, a different device can be sent a recommendation of the mark and corresponding content associated with the mark when the different device is within a radius of the location of the mark.

The systems and methods described herein can map a plurality of marks when the marks are scanned by a plurality of different devices. For example, data can be collected when a mark is scanned that can be utilized to map the mark and determine popularity information relating to the mark. In this example, the mapped mark and corresponding content associated with the mark can be provided to a different device even when the different device does not scan the mark. In some examples, a recommendation can be provided to the different device. The recommendation can include the content associated with the mark. The recommendation can be provided to the different device based on a location of the different device and/or a popularity of the mark. Thus, the systems and methods described herein can be utilized to provide recommendations to devices that includes content associated with a number of marks without the devices having to scan the marks.

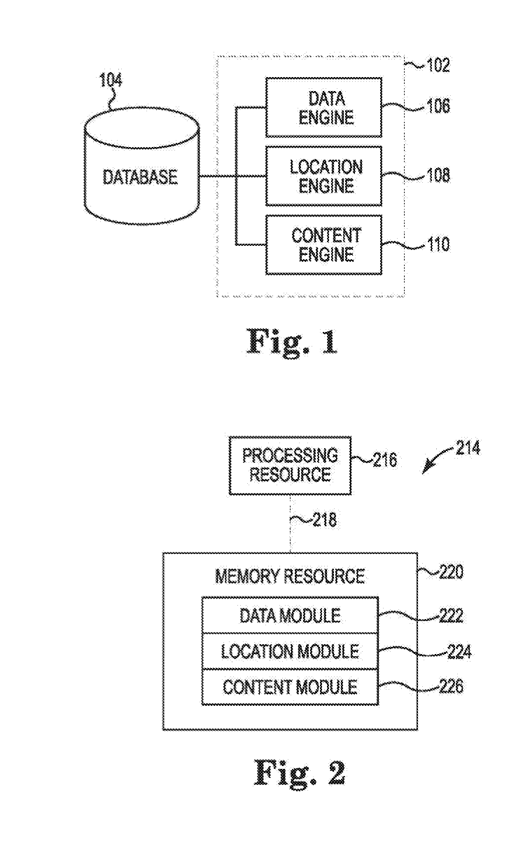

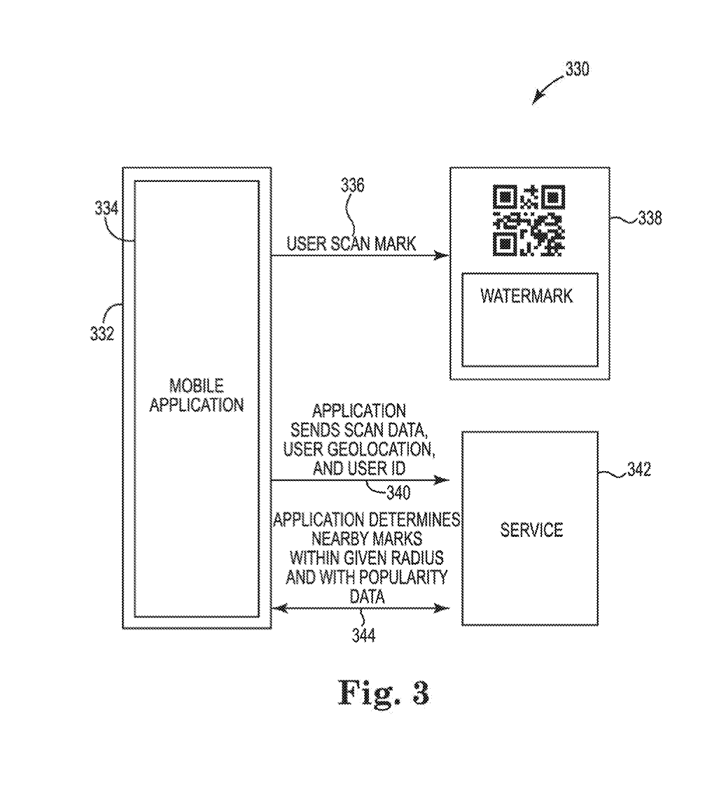

FIGS. 1 and 2 illustrate examples of system 100 and computing device 214 consistent with the present disclosure. FIG. 1 illustrates a diagram of an example of a system 100 for providing mark triggered content recommendations consistent with the present disclosure. The system 100 can include a database 104, a mark triggered content recommendation system 102, and/or a number of engines (e.g., data engine 106, location engine 108, content engine 110, etc.). The mark triggered content recommendation system 102 can be in communication with the database 104 via a communication link, and can include the number of engines (e.g., data engine 106, location engine 108, content engine 110, etc.). The mark triggered content recommendation system 102 can include additional or fewer engines that are illustrated to perform the various functions as will be described in further detail in connection with FIGS. 3-5.

The number of engines (e.g., data engine 106, location engine 108, content engine 110, etc.) can include a combination of hardware and programming, but at least hardware, that is configured to perform functions described herein (e.g., receive a scanned image ID of a first mark with a corresponding location of the first mark, determine a location of a second mark within a radius of the corresponding location of the first mark, provide content associated with the first mark and a recommendation of content associated with the second mark, etc.). The programming can include program instructions (e.g., software, firmware, etc.) stored in a memory resource (e.g., computer readable medium, machine readable medium, etc.) as well as hard-wired program (e.g., logic).

The data engine 106 can include hardware and/or a combination of hardware and programming, but at least hardware, to receive a scanned image ID of a first mark with a corresponding location of the first mark. Receiving the scanned image ID of a first mark can include receiving an identification for the first mark and/or image (e.g., QR code, barcode, watermark, etc.) that has been scanned by a device (e.g., mobile device, smart phone, etc.). The corresponding location can be geolocation (e.g., coordinate information, coordinate position, etc.) of a physical location of the mark.

In some examples, the first mark can be a mark that is associated with content. That is, the first mark can be scanned by a device and content associated with the mark can be provided to the user. In a specific example, the mark can be a QR code, bar code, and/or watermark that can include corresponding content such as text, videos, audio recordings, and/or links to websites. This example, the content can be provided to a device when the device scans the mark.

The location engine 108 can include hardware and/or a combination of hardware and programming, but at least hardware, to determine a location of a second mark within a radius of the corresponding location of the first mark. Determining the location of the second mark within a radius of the corresponding location of the first mark can include utilizing a mapping of second mark location to determine if the second mark is within a radius of the corresponding location of the first mark and/or device that has scanned the first mark. The mapping of the second mark location can be generated by the system 100. For example, the data engine 106 can receive a scanned image ID of the second mark with a corresponding location of the second mark. In this example, the location engine 108 can map the second mark to the corresponding location and utilize the map to determine when the second mark is within a radius of the corresponding location of the first mark and/or device that has scanned the first mark.

The content engine 110 can include hardware and/or a combination of hardware and programming, but at least hardware, to provide content associated with the first mark and a recommendation of content associated with the second mark. In some examples, the content associated with the first mark can include content that would previously appear when scanning the first mark. For example, a QR code can include corresponding content associated with the QR code that can be provided to a device when the QR code is scanned by the device. In addition to the provided content, the device can also receive a recommendation of content associated with a different QR code and/or different mark. The recommendation can be provided based on a location of the different QR code and/or a popularity of the different QR code. In some examples, the popularity can be based on a frequency of users scanning both QR codes and/or a frequency of users scanning the different QR code that have similar interests to a user scanning the QR code.

FIG. 2 illustrates a diagram of an example computing device 214 consistent with the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a function (e.g., receive a scanned image ID of a mark with a corresponding location of the mark from a first device, determine when a second device is within a radius of the corresponding location of the mark, provide a recommendation to the second device for content associated with the mark when the second device is within the radius of the corresponding location of the mark, provide the content associated with the mark to the second device upon selection of the recommendation, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., data module 222, location module 224, content module 226, etc.) can include CRI that when executed by the processing resource 216 can perform functions. The number of modules (e.g., data module 222, location module 224, content module 226, etc.) can be sub-modules of other modules. For example, the data module 222 and location module 224 can be sub-modules and/or contained within the same computing device. In another example, the number of modules (e.g., data module 222, location module 224, content module 226, etc.) can comprise individual modules at separate and distinct locations (e.g., CRM, etc.).

Each of the number of modules (e.g., data module 222, location module 224, content module 226, etc.) can include instructions that when executed by the processing resource 216 can function as a corresponding engine as described herein. For example, the data module 222 can include instructions that when executed by the processing resource 216 can function as the data engine 106.

FIG. 3 illustrates an example system 330 for providing mark triggered content recommendations consistent with the present disclosure. The system 330 can be utilized to provide recommendations (e.g., content recommendations) for content associated with a number of marks 338. The recommendations can be provided to a device 332 upon scanning a different mark and/or upon the mark being within a radius of the device 332. In some examples, the device 332 can request a recommendation by sending a location of the device to the system 330. The system 330 can provide content associated with the number of marks 338 more efficiently compared to previous systems and methods by providing access to content associated with the number of marks 338 without a device 332 having to scan each or any of the number of marks 338.

The system 330 can include a device 332. The device 332 can be a computing device (e.g., system 100, computing device 214, etc.) that includes an application 334 (e.g., engines, modules, instructions, logic, etc.). The application 334 can include a scanning function (e.g., function of reading a mark, function of scanning a mark, etc.). In some examples, the device 332 can be a mobile device, such as a cell phone that may or may not include a scanning function. When the device 332 includes an application 334, the application 334 can be utilized at 336 to scan a number of marks 338.

The number of marks 338 can include QR codes, bar codes, watermarks, and/or images, among other types of marks that can be scanned to receive content that corresponds to the mark. For example, a QR code can be scanned by the device 332 and the device 332 can be provided video content associated with the QR code.

The application 334 can also include a data collection function that collects data associated with the scanned mark 338. For example, the application 334 can determine and/or collect data such as location information, time information, user identification information, mark information, and/or content information associated with the mark. The application 334 at 340 can send the determined and/or collected data to a service 342. The service 342 can include a database and/or cloud service to collect the data determined and/or collected by the application 334.

The service 342 can store the data from the application 334 and utilize the data from the application 334 to map the scanned mark to a location associated with the physical location of the mark. The service 342 can utilize the data from the application 334 determine a quantity of times (e.g., frequency, etc.) the mark is scanned and/or a quantity of times the mark is scanned over a period of time. The quantity can be utilized to determine a popularity of the mark. In some examples, the service 342 can utilize the data from the application to determine a type of user that may be interested in the content associated with the mark. For example, the data from the application 334 can include a user ID that can be associated with user data (e.g., user interests, friends of the user, activities of the user, user profile, etc.) to determine a type of user that may be interested in the content associated with the content of the mark.

The service 342 can utilize the data from the application 334 to determine a number of recommendations for a user of the device 332. At 344, the service 342 can determine and/or send a recommendation for a number of marks within a radius of the physical location of the scanned mark 338. In some examples, the service 342 can also determine and/or send a recommendation for a number of marks to the device 332 based on a popularity of the number of marks. The recommendation for the number of marks can include content associated with the number of marks and/or a link to the content associated with the number of marks. Thus, the recommendation for the number of marks can enable the device 332 to access or be provided with content associated with the number of marks without having to scan the number of marks.

In some examples, the service 342 can provide recommendations to t device 332 even when the device 332 has not scanned a mark 338 at 336. For example, the service 342 can receive location information from the device 332. In this example, the service 342 can send recommendations to the device 332 when the service 342 determines, based on the received location information, that a mark is within a particular radius of the device 332. In some examples, the service 342 can send recommendations to the device 332 when the device 332 is within a particular radius of the physical location of the mark.

In some examples, the service 342 can utilize a popularity of the mark for sending recommendations to the device 332. The popularity of the mark can be based on a quantity of scans for the mark, a category of content associated with the mark, and/or a type of user (e.g., properties of the user profile, etc.) scanning the mark. In some examples, the service 342 can utilize the popularity of the mark to determine which of a plurality of recommendations are sent to the device 332. For example, the service 342 can utilize the popularity of the mark to rank a plurality of recommendations corresponding to content of a plurality of marks within a radius of the device 332. In this example, a number of top ranked recommendations (e.g., ranked above a threshold, etc.) can be sent to the device 332.

The system 330 can be utilized to provide content associated with a mark via a number of recommendations without a user having to locate a physical location of the mark and/or scanning the mark. The system 330 can receive and map a plurality of scanned marks from a plurality of different users and user devices. The map of the plurality of scanned marks can include popularity data such as a quantity of scans for each mark. In some examples, the system 330 can provide content associated with a mark to a device without the device having a capability of scanning the mark. The system 330 provides a greater distribution of content associated with marks and can also provide recommendations for content associated with marks based on location and/or popularity data.

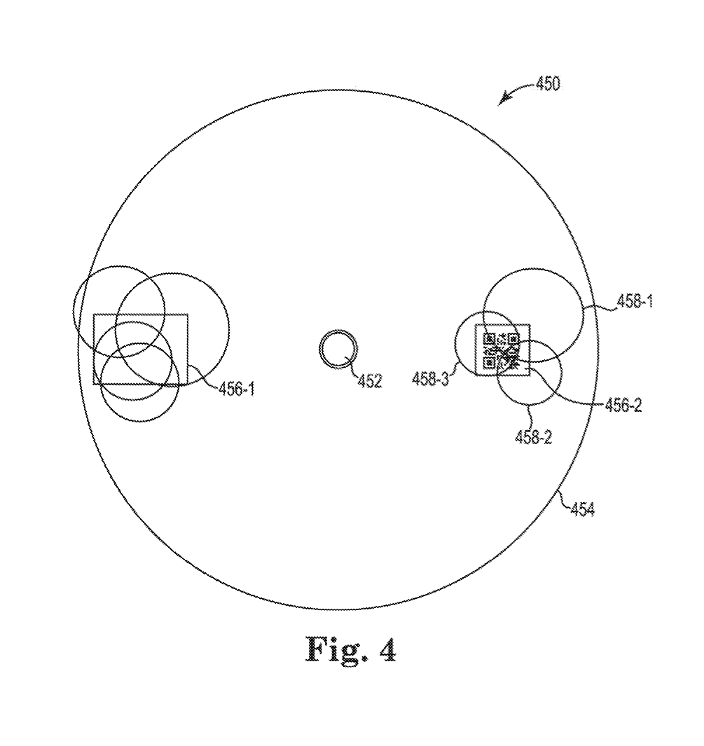

FIG. 4 illustrates an example system 450 for providing mark triggered content recommendations consistent with the present disclosure. The system 450 can represent one example of a user device 452 (e.g., computing device, mobile computing device, cell phone, etc.) receiving a number of recommendations that include content associated with a plurality of marks 456-1, 456-2 that are within a radius 454 of the user device 452.

The system 450 can utilize a service (e.g., service 342 as referenced in FIG. 3, cloud service, etc.) to provide a number of recommendations to the user device 452 when the marks 456-1, 456-2 are within the radius 454 of the user device 452. As described herein, the service can receive location information (e.g., a geolocation, a physical location, etc.) from the user device 452 and determine a radius 454 around the location of the user device 452. The radius 454 can be utilized by the service to determine a number of marks 456-1, 456-2 within the radius 454 of the user device 452. In some examples, the service can determine that the number of marks 456-1, 456-2 within the radius 454 of the user device 452 are relevant (e.g., relevant location, relevant to properties of a user profile of the user device 452, etc.) to the user. In these examples, the service can send a recommendation for content associated with mark 456-1 and a recommendation for content associated with mark 456-2.

In some examples, the service can determine a physical location of the number of marks 456-1, 456-2 based on a number of scan locations 458-1, 458-2, 458-3. The number of scan locations 458-1, 458-2, 458-3 can be determined based on location information received from devices that have previously scanned the mark 456-2. For example, a first device may have scanned the mark 456-2 at a first time and sent location information to the service indicating a first scan location 458-1. In this example, a second device may have scanned the mark 456-2 at a second time and sent location information to the service indicating a second scan location 458-2. Furthermore, in this example, a third device may have scanned the mark 456-3 at a third time and sent location information to the service indicating a third scan location 458-3. The number of scan locations 458-1, 458-2, 458-3 for the mark 456-2 can be utilized to map the mark 456-2. Mapping of the mark 456-2 can be utilized when determining whether the mark 456-2 is within the radius 454 of the user device 452.

In some examples, the service can determine a popularity of the number of marks 456-1, 456-2. The popularity of the number of marks 456-1, 456-2 can be determined based on a quantity of scans for each of the number of marks 456-1, 456-2. For example, the quantity of scans can be a quantity of times that devices scan the number of marks 456-1, 456-2. In this example, the mark 456-1 can have a total of four scan locations and the mark 456-2 can have a total of three scans. In this example, the service can determine that the mark 456-1 has a greater popularity compared to the mark 456-2.

In some examples, the service can rank the number of marks 456-1, 456-2 based on the popularity of the number of marks 456-1, 456-2 and/or the quantity of times each of the number of marks 456-1, 456-2 have been scanned. The service can send recommendations to the user device 452 based on the ranking of the number of marks 456-1, 456-2. For example, the service can send a number of recommendations that are considered top ranked marks and/or top ranked content associated with the marks. In some examples, the top ranked marks and/or top ranked content associated with the marks can include a threshold number of marks near a top ranked mark.

In some examples, the popularity of the marks 456-1, 456-2 can be based on content associated with the marks 456-1, 456-2. For example, the popularity of the marks 456-1, 456-2 for a particular user device 452 can be based on a user profile of the user device 452 compared to user profiles of devices that previously scanned the marks 456-1, 456-2. That is, the marks 456-1, 456-2 can have a greater popularity when there are a greater number of similarities between the user profile of the user device 452 and user profiles of devices that have previously scanned the marks 456-1, 456-2.

The system 450 can be utilized to provide recommendations to the user device 452 when marks associated with content are within the radius 454 of the user device 452. The recommendations can notify the user device 452 that marks 456-1, 456-2 are within the radius 454 of the user device 452. In some examples, the recommendations can include the content associated with the marks 456-1, 456-2 and/or can include a link (e.g., hyperlink, etc.) to the content associated with the marks 456-1, 456-2. In some examples, the recommendations can include a physical location of the marks 456-1, 456-2 to notify the user device 452 where the physical location of the marks 456-1, 456-2 are compared to the physical location of the user device 452. The system can provide content associated with the marks 456-1, 456-2 without the user device 452 having to locate and/or scan the marks 456-1, 456-2.

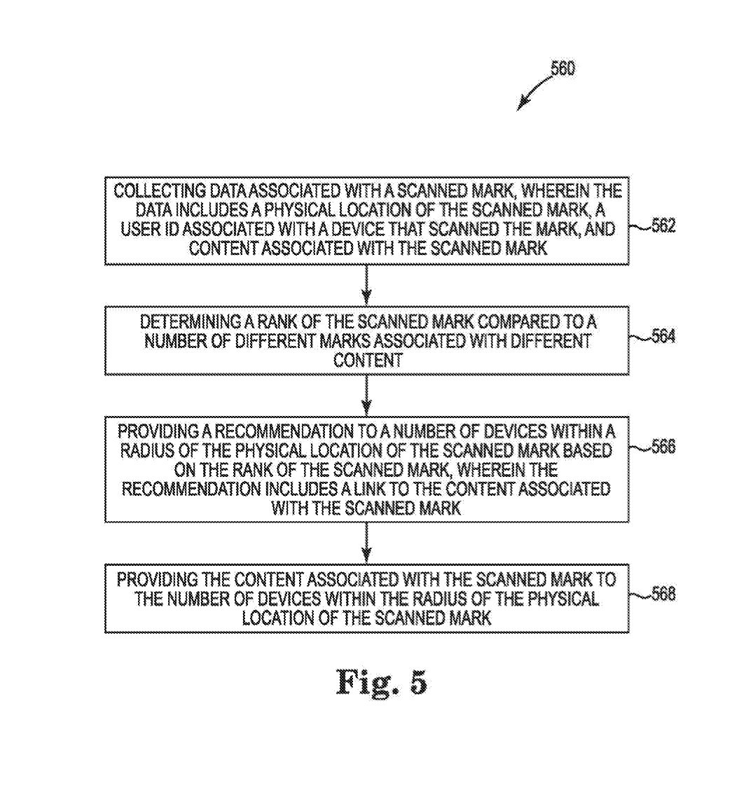

FIG. 5 illustrates an example method 560 for providing mark triggered content recommendations consistent with the present disclosure. The method 560 can be executed and/or performed by a system 100 as referenced in FIG. 1 and/or a computing device 214 as referenced in FIG. 2. The method 560 can be utilized to provide a number of recommendations for content associated with a mark without having to scan the mark. As described herein, the recommendations can be based on location and/or popularity of the mark with respect to a device.

At 562, the method 560 can include collecting data associated with a scanned mark, wherein the data includes a physical location of the scanned mark, a user ID associated with a device that scanned the mark, and content associated with the scanned mark. Collecting data associated with the scanned mark can be performed by a service (e.g., service 342 as referenced in FIG. 3, etc.). That is, a service can receive data associated with the scanned mark from a plurality of different devices that each scan the mark and send data associated with the scanned mark to the service.

The data associated with the scanned mark can be utilized to map the location of the scanned mark and corresponding content associated with the scanned mark. The mapped locations of scanned marks can be utilized to determine when a device is within a particular area of the mark and/or when the mark is within a particular radius of the device. The mapped locations of the scanned marks can be generated without having to input the location of each of the marks since the mapping is based on data received by a plurality of devices that have scanned the mark.

At 564, the method 560 can include determining a rank of the scanned mark compared to a number of different marks associated with different content. The rank can be determined based on a popularity of the mark. For example, the rank can be determined based on a quantity of times the mark is scanned by devices. In another example, the rank can be determined based on user profiles of the user of devices that have scanned the mark. In this example, the user profile of a device can be compared to user profiles of devices that have previously scanned the mark and/or accessed the content associated with the mark to determine a similarity.

At 566, the method 560 can include providing a recommendation to a number of devices within a radius of the physical location of the scanned mark based on the rank of the scanned mark, wherein the recommendation includes a link to the content associated with the scanned mark. Providing the recommendation to the number of devices can include a service sending content associated with the scanned mark to the number of devices. In some examples, the recommendation can include the content associated with the scanned mark and/or a link to the content associated with the scanned mark.

At 568, the method 560 can include providing the content associated with the scanned mark to the number of devices within the radius of the physical location of the scanned mark. Providing the content associated with the scanned mark to the number of devices within the radius of the physical location of the scanned mark can include sending or allowing access to the content associated with the scanned mark. That is, the number of devices are able to receive and/or are able to view the content associated with the scanned mark without having to the scan the mark.

In some examples, the method 560 can include determining a popularity of the scanned mark based on a quantity scans associated with the mark at the physical location. As described herein, determining the popularity of the scanned mark can include determining a quantity of scans associated with the mark and/or a user profile associated with devices that have scanned the mark previously. In some examples, the user profile of the device within the radius of the mark can be compared to user profiles of devices that have previously scanned the mark to determine a similarity between the profiles.

In some examples, the method 560 can include providing a recommendation to a particular device of the number of devices, wherein the recommendation includes a plurality of visual marks within a radius of the particular device. The recommendation to the particular device can include a plurality of marks that are within a physical radius of the particular device. The recommendation can include content associated with each of the plurality of visual marks and/or a link to content associated with each of the plurality of visual marks.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What claimed:

1. A system, comprising:
a data engine to receive a scanned image ID of a first mark with a corresponding location of the first mark;
a location engine to determine a location of a second mark within a radius of the corresponding location of the first mark; and
a content engine to provide content associated with the first mark and a recommendation of content associated with the second mark.

2. The system of claim 1, comprising a filter engine to remove content associated with a number of marks outside the radius of the corresponding location.

3. The system of claim 1, wherein the data engine receives a user ID corresponding to a device that captured the scanned image ID with a corresponding time stamp.

4. The system of claim 1, wherein the data engine stores the scanned image ID with the corresponding location of the first mark to be compared with location information from a plurality of mobile devices.

5. The system of claim 4, wherein the stored scanned image ID with the corresponding location of the first mark is presented to a number of devices within the radius of the corresponding location of the first mark.

6. The system of claim 4, wherein the stored scanned image ID with the corresponding location of the first mark is utilized to determine a rating of the first mark compared to the second mark and a plurality of other marks.

7. The system of claim 1, wherein the recommendation includes a link to content associated with the second mark.

8. A non-transitory computer readable medium storing instructions executable by a processor for providing mark triggered content recommendations, wherein the instructions are executable to:
receive a scanned image ID of a mark with a corresponding location of the mark from a first device;
determine when a second device is within a radius of the corresponding location of the mark;
provide a recommendation to the second device for content associated with the mark when the second device is within the radius of the corresponding location of the mark; and
provide the content associated with the mark to the second device upon selection of the recommendation.

9. The medium of claim 8, wherein the recommendation provides scanless access to the content associated with the mark.

10. The medium of claim 8, wherein the received canned image ID of the mark is utilized to map the location to the mark.

11. The medium of claim 8, wherein the mark is a visual mark displayed at the corresponding location.

12. A method for providing mark triggered content recommendations, comprising:
collecting data associated with a scanned mark, wherein the data includes a physical location of the scanned mark, a user ID associated with a device that scanned the mark, and content associated with the scanned mark;
determining a rank of the scanned mark compared to a number of different marks associated with different content;
providing a recommendation to a number of devices within a radius of the physical location of the scanned mark based on the rank of the scanned mark, wherein the recommendation includes a link to the content associated with the scanned mark; and
providing the content associated with the scanned mark to the number of devices within the radius of the physical location of the scanned mark.

13. The method of claim 12, wherein determining the rank includes determining a popularity of the scanned mark based on a quantity scans associated with the mark at the physical location.

14. The method of claim 12, wherein providing the recommendation includes providing a recommendation to a particular device of the number of devices, wherein the recommendation includes a plurality of visual marks within a radius of the particular device.

15. The method of claim 14, wherein the recommendation includes a link to content associated with each of the plurality of visual marks.
